(19) United States
(12) Patent Application Publication
(10) Pub. No.: US 2013/0263812 A1
(43) Pub. Date: Oct. 10, 2013

(54) Internal Combustion Engine

(71) Applicant: ANDREAS STIHL AG & CO. KG, Waiblingen (DE)

(72) Inventors: Werner Geyer, Berglen (DE); Roland Adam, Besigheim (DE); Lutz Volckart, Goppingen (DE); Martin Leiendecker, Goppingen (DE)

(73) Assignee: Andreas Stihl AG & Co. KG, Waiblingen (DE)

(21) Appl. No.: 13/853,097

(22) Filed: Mar. 29, 2013

(30) Foreign Application Priority Data
Apr. 4, 2012 (DE) 10 2012 006 852.2

(51) Int. Cl. F02F 1/00

(52) U.S. Cl. CPC F02F 1/004
USPC 123/193.2

(57) ABSTRACT

An internal combustion engine has a cylinder liner arranged in the cylinder. A piston moves reciprocatingly in a direction of the longitudinal cylinder axis in the cylinder and is guided within the cylinder liner across a section of a movement path of the piston in the cylinder. A combustion chamber disposed in the cylinder is delimited by the piston. In a crankcase, a crankshaft is rotatably supported by a crankshaft bearing, wherein the crankshaft is driven in rotation by the piston about an axis of rotation of the crankshaft. A position of the cylinder liner relative to the crankcase is secured with form fit by a securing element located at an end face of the cylinder liner that is facing the crankcase. No loads are transmitted into the cylinder liner from the crankshaft bearing through the end face of the cylinder liner that is facing the crankcase.

### BACKGROUND OF THE INVENTION

The invention relates to an internal combustion engine comprising a cylinder in which a cylinder liner is arranged wherein in the cylinder a piston is reciprocatingly supported so as to move in the direction of a longitudinal cylinder axis. The piston is guided in the cylinder liner at least across a section of its movement path and delimits a combustion chamber. The internal combustion engine further comprises a crankcase in which a crankshaft is supported by means of at least one crankshaft bearing so as to be rotatable wherein the crankshaft is driven in rotation by the piston about an axis of to rotation of the crankshaft. The position of the cylinder liner relative to the crankcase is positively secured by means of a securing element which is arranged at the end face of the cylinder liner that is facing the crankcase.

AT 004 171 U1 discloses an internal combustion engine, i.e., a two-stroke engine, in which the sliding surface for the piston is delimited across a portion of the piston movement path by means of a cylinder liner. The cylinder liner is pressed into the cylinder. The cylinder line has a shoulder by means of which the cylinder liner is supported on the crankcase. In this way, the cylinder liner is secured against axial displacement.

EP 0 059 872 A1 discloses a motor for model vehicles that is configured as a single cylinder two-stroke motor. The crankshaft of this motor is supported only at one end. The piston is guided in a cylinder liner that is clamped between the cylinder and the cylinder head. The cylinder liner is supposed to center the cylinder and the crankcase relative to each other. In order to avoid twisting that could lead to an oval distortion of the cylinder liner, it is provided that the cylinder and the cylinder head are not attached simultaneously with identical bolts. For the attachment of cylinder and crankcase separate fastening elements are provided.

### SUMMARY OF THE INVENTION

It is an object of the present invention to provide an internal combustion engine of the aforementioned kind that is of a simple configuration and in which deformation of the cylinder liner is prevented.

In accordance with the present invention, this is achieved in that the internal combustion engine is designed such that through the end face of the cylinder liner which is facing the crankcase no loads originating from the crankshaft bearing are transmitted into the cylinder liner.

It has been found that bearing loads that are introduced into the cylinder liner through the crankshaft bearing can be the decisive factor for deformations of the cylinder liner. In particular in case of compact, small-size internal combustion engines, the crankshaft bearing can be arranged advantageously immediately below the cylinder liner. In this way, a large proportion (majority) of the bearing loads that are produced in operation are introduced into the cylinder liner. It is also known to support the crankshaft bearing directly on the cylinder liner. It has been found that the deformations of the cylinder liner in operation can be prevented in a simple way in that no loads from the crankshaft bearing are transmitted into the cylinder liner though the end face of the cylinder liner that is facing the crankcase. Advantageously, the loads from the crankshaft bearing are transmitted directly into the cylinder. In this way, a deformation of the cylinder liner is prevented in a simple way.

Advantageously, the securing element is arranged such that it absorbs loads from the crankshaft bearing. For absorption of the loads no additional component is therefore required. The securing element secures, on the one hand, the position of the cylinder liner in the cylinder and, on the other hand, the securing element introduces the bearing loads into the cylinder of the internal combustion engine. In order to ensure that no loads can be introduced into the cylinder liner by means of the securing element, it is advantageously provided that the securing element has a spacing relative to the end face of the cylinder liner. The spacing or distance is advantageously less than approximately 1 mm. Alternatively, it can also be provided that the cylinder liner is contacting with its end face the securing element. This contact is however to be selected such that, taking into consideration all tolerances that may occur during manufacture, no significant loads can be introduced into the cylinder liner in operation. Significant loads are in this context loads that may lead to deformation of the cylinder liner.

A simple configuration results when the securing element is formed at least partially by the crankcase. Advantageously, between crankcase and cylinder a gasket is arranged that forms also a part of the securing element. Since the mechanical stability of the gasket is usually not sufficient in order to secure the cylinder liner axially, the crankcase and the gasket together form advantageously the securing element. The bearing seat for the crankshaft bearing is advantageously formed completely on the crankcase. In this way, no additional components are required for the securing element; instead, the securing element is formed by already existing components. A simple configuration results when the crankcase is formed by an upper or top crankcase part and lower or bottom crankcase part wherein the two crankcase parts together define a bearing seat for the crankshaft bearing. The two crankcase parts are advantageously joined at a joining plane which contains the crankshaft axis of rotation and which is perpendicular to the longitudinal cylinder axis.

It may also be provided that the securing element is formed at least partially by an outer ring of a crankshaft bearing of the crankshaft. In particular, the outer ring of the crankshaft bearing forms the securing element without any further components. Advantageously, the crankcase is sealed at the crankshaft by a seal relative to the environment; the seal is supported on the outer ring of the crankshaft bearing. In this way, a compact configuration is achieved. The outer ring of the crankshaft bearing projects advantageously into the area of the cylinder where it is supported on the cylinder. In this connection, it is advantageously provided that the outer ring is resting on the cylinder with less than approximately 70%, in particular less than approximately 60%, of its ring width that is measured parallel to the axis of rotation of the crankshaft. In this way, a compact configuration is achieved. The crankshaft bearing can be arranged in the area of the cylinder liner because the outer ring of the crankshaft bearing is extended into the area below the cylinder liner. By means of the outer ring of the crankshaft bearing the bearing loads which are produced in operation are introduced directly into the cylinder so that no bearing loads of the crankshaft bearing will act on the cylinder liner in operation.

A compact configuration is achieved when the crankshaft bearing is displaced inwardly relative to the cylinder, i.e., into the area of the cylinder liner. Advantageously, it is provided for this purpose that the outer circumference of the cylinder liner in a section plane which contains the longitudinal cylinder axis and the axis of rotation of the crankshaft has relative to the longitudinal cylinder axis a greater spacing than the outer side of the inner ring of the crankshaft bearing the outer side facing away from the crankcase. When the support action of the crankshaft bearing is realized by means of the crankcase, the outer side of the outer ring of the crankshaft bearing can also have a smaller spacing relative to the longitudinal cylinder axis than the outer circumference of the cylinder liner.

The cylinder liner is advantageously formed as a partial cylinder liner that ends before the top edge of the outlet opening of the combustion chamber, the top edge facing the top (cover) of the combustion chamber. The cylinder liner extends therefore only across a portion of the cylinder length so that the piston is supported across a portion of its movement path directly on the cylinder and is supported at least partially on the cylinder liner across a further portion of its movement path located adjacent to the bottom dead center. The cylinder liner is advantageously pressed into the cylinder. In particular, the cylinder liner has at its end that is facing the cover of the combustion chamber a shoulder with which it is supported on the cylinder. It has been found that a deformation of the cylinder liner can be prevented alternatively or additionally also when the cylinder liner is connected with the cylinder by a form fit connection which acts in radial direction relative to the longitudinal cylinder axis. The connection between cylinder liner and cylinder can be, for example, realized by means of a tongue-and-groove connection where a web (tongue) that is provided on the cylinder or the cylinder liner and is extending about the longitudinal cylinder axis projects into a matching groove at the counter part, i.e, the cylinder liner or the cylinder.

A simple configuration of the internal combustion engine is achieved when the internal combustion engine has at least one transfer passage that connects the crankcase interior in the range of bottom dead center of the piston with the combustion chamber wherein the transfer passage extends between the cylinder and the cylinder liner and is formed at least partially as a depression of the outer circumference of the cylinder liner.

### BRIEF DESCRIPTION OF THE DRAWING

FIG. 1 is a schematic section illustration of an internal combustion engine.

FIG. 2 is a perspective illustration of cylinder and crankcase of the two-stroke engine of FIG. 1.

FIG. 3 is a perspective section illustration of the assembly that is illustrated in FIG. 2.

FIG. 4 is another perspective section illustration of the assembly that is illustrated in FIG. 2.

FIG. 5 shows the detail V of FIG. 4 on an enlarged scale with additional components being shown.

FIG. 6 is a longitudinal section view of the assembly of FIG. 2.

FIG. 7 is a perspective longitudinal section view of the assembly of FIG. 2.

FIG. 8 is an exploded view of the assembly of FIG. 2.

FIG. 9 is an exploded view of the assembly of FIG. 2.

FIG. 10 is a perspective longitudinal section view of an embodiment of the invention.

FIG. 11 shows the detail XI of FIG. 10 on a larger scale.

FIG. 12 is a schematic side view of a further embodiment of an internal combustion engine.

FIG. 13 is a schematic section illustration along the line XIII-XIII of FIG. 12.

### DESCRIPTION OF THE PREFERRED EMBODIMENTS

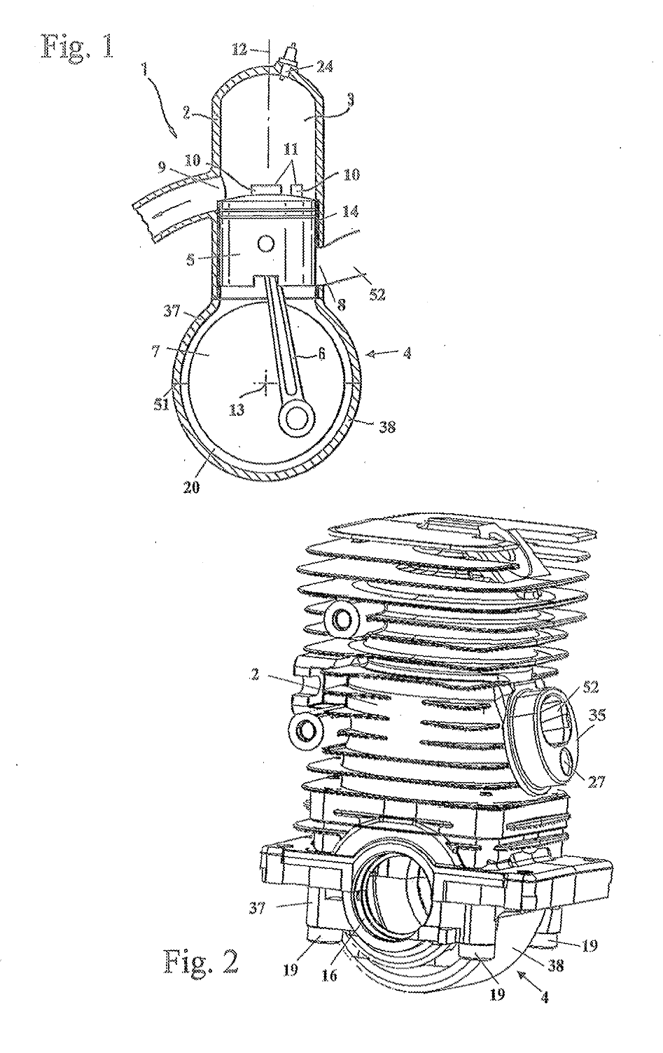

FIG. 1 shows schematically an internal combustion engine 1 which is embodied as a two-stroke engine. The internal combustion engine 1 is advantageously a single cylinder motor that is a drive motor for a hand-held power tool such as a motor chain saw, a cut-off machine, a trimmer, a lawnmower or the like. The internal combustion engine 1 has a cylinder 2 in which a piston 5 is supported so as to move in reciprocating fashion. A combustion chamber 3 is formed in the cylinder 2 and is delimited by the piston 5. The piston 5 drives by means of a connecting rod 6 a crankshaft 7 that is rotatably supported in the crankcase 4 about an axis of rotation 13 of the crankshaft 7. The crankshaft 7 is arranged in the interior 20 of the crankcase 4. In the range of bottom dead center of the piston 5 the crankcase interior 20 is connected by means of transfer passages 10 with the combustion chamber 3. The transfer passages 10 open with transfer ports 11 into the combustion chamber 3. Supply of fuel/air mixture or of combustion air is provided by means of the inlet opening 8 that is piston-controlled by piston 5 and opens into the crankcase interior 20. A supply passage 52 opens at the inlet opening 8. An outlet opening 9 is provided at the combustion chamber. The cylinder 2 has a longitudinal cylinder axis 12.

In operation, the inlet opening 8 is open in the range of top dead center of the piston 5 toward the crankcase interior 20 and fuel/air mixture is aspirated into the crankcase interior 20. It is also possible to provide that by means of the inlet opening 8 only combustion air is aspirated and the supply of fuel is realized, for example, by means of an injection valve, into the crankcase interior 20, into one or several transfer passages 10, or directly into the combustion chamber 3. The fuel/air mixture or the combustion air in the crankcase interior 20 is compressed upon downward stroke of the piston 5 and flows into the combustion chamber 3 as soon as the transfer ports 11 open into the combustion chamber 3. In this connection, the exhaust gases that are present in combustion chamber 3 are scavenged via the outlet opening 9. The fuel/air mixture in the combustion chamber 3 is compressed upon upward stroke of the piston 5 and in the range of top dead center of the piston is ignited by spark plug 24. Due to the combustion in the combustion chamber 3, the piston 5 is accelerated toward bottom dead center. As soon as the outlet opening 9 has been released by the piston 5, the exhaust gases flow out of the combustion chamber 3 and are flushed out of the combustion chamber 3 by means of fresh mixture that is coming in through the transfer passages 10.

As schematically indicated in FIG. 1, in the area of the cylinder 2 that is facing the crankcase 4 a cylinder liner 14 is arranged in the cylinder bore. The piston 5 is guided in the cylinder liner 14 in the range of its bottom dead center. The cylinder liner 14 is advantageously pressed into the cylinder 2 and extends in the embodiment in the direction of the longitudinal cylinder axis 12 up to the outlet opening 9 and the transfer ports 11. The inlet opening 8 is advantageously completely formed within the cylinder liner 14. However, it can also be provided that the cylinder liner 14 delimits only a portion of the inlet opening 8. The cylinder liner 14 can however extend also across the entire sliding surface of the piston 5 in the cylinder 2.

As schematically shown in FIG. 1, the crankcase 4 is comprised of a top crankcase part 37 that is facing the cylinder 2 and a bottom crankcase part 38 that is facing away from the cylinder 2. The two crankcase parts 37 and 38 are contacting each other at a joining plane 51 that extends perpendicularly to the longitudinal cylinder axis 12 and contains the axis of rotation 13 of the crankshaft 7.

FIG. 2 shows the construction of the internal combustion engine 1 in detail wherein only the cylinder 2 and the crankcase 4 are shown. As illustrated in FIG. 2, the two crankcase parts 37 and 38 are screw-connected with the cylinder 2 by screws 19 which are screwed in a direction from the bottom crankcase part 38 through the top crankcase part 37 upward into the cylinder 2. The cylinder 2 has an inlet socket 35 through which the supply passage 52 is guided. Also, a pulse channel 27 is extending through the inlet socket 35.

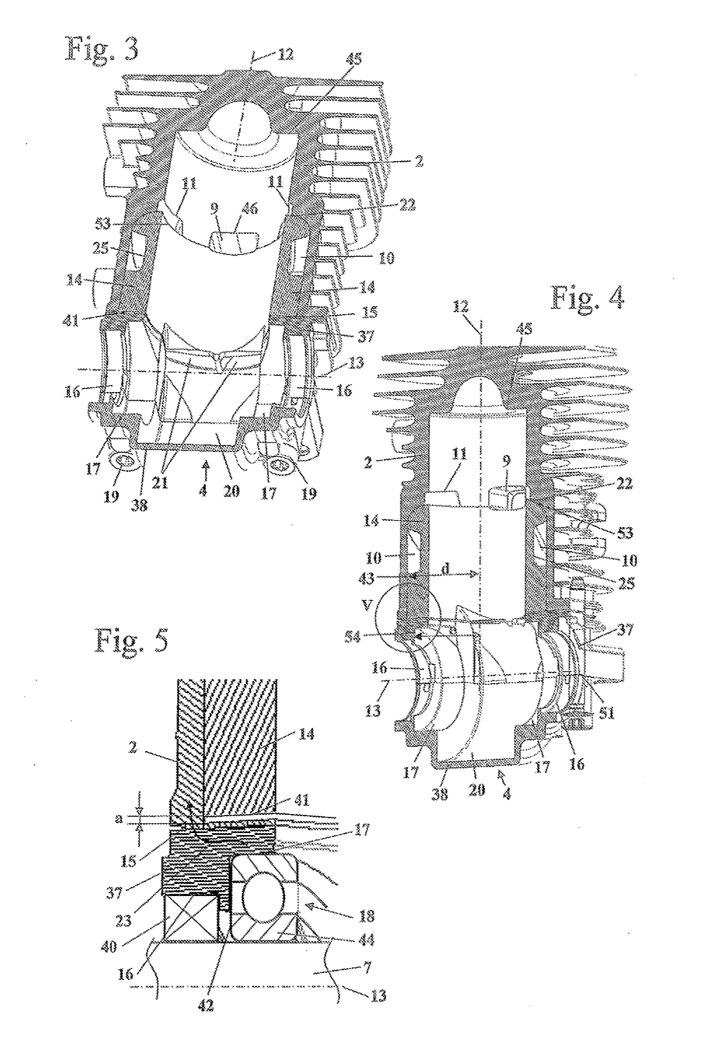

FIG. 3 and FIG. 4 show the arrangement and configuration of the cylinder liner 14 in detail. The cylinder liner 14 extends up to a bottom edge 53 of the transfer ports 11. The bottom edge 53 of the transfer ports 11 is the side of the transfer ports 11 that is facing the crankcase 4. The cylinder liner 14 ends thus significantly below the top side 46 of the outlet opening 9. The top side 46 is the side of the outlet opening 5 which is facing the combustion chamber cover 45.

As shown in FIG. 3 and FIG. 4, the cylinder liner 14 has at its side that is facing the combustion chamber cover 45 a rounded shoulder 22 that extends at a radius and is supported on a step of the cylinder 2 that has a matching radius. The cylinder liner 14 has at its exterior side depressions 25 that form transfer passages 10. The transfer passages 10 open with openings 21 (shown in FIG. 3) into the crankcase interior 20. In the illustrated embodiment two openings 21 are provided which are arranged at the side of the outlet opening 9 which is facing the crankcase 4. The transfer passages 10 extend spirally or in a coil shape away from the openings 21 about the longitudinal cylinder axis 12. The transfer passages branch into two branches each and the branches open with two separate transfer ports 11 into the combustion chamber 3. The internal combustion engine 1 has two openings 21 and four transfer ports 11. It can also be provided that all transfer passages 10 open at a common opening 21 into the crankcase interior 20.

Between the cylinder 2 with the cylinder liner 14 and the top crankcase part 37 a gasket 15 is arranged. On the gasket 15 the top crankcase part 37 is resting. The top crankcase part 37 extends in the direction of the axis of rotation 13 of the crankshaft 7 across the entire width of the cylinder 2 and the cylinder liner 14. The two crankcase parts 37 and 38 form together two bearing seats 17 for the crankshaft bearings 18; one of them is shown schematically in FIG. 5. The crankshaft 7 is supported in the crankcase 4 at both ends adjacent to the crank webs (not shown) and the connection to the connecting rod 6. On the outwardly positioned side of the bearing seats 17 facing away from the crankcase interior 20 sealing seats 16 are formed in which seals 40 are arranged; FIG. 5 shows one of them schematically. The seals 40 serve for sealing the crankcase interior 20 relative to the environment. As shown in FIG. 3, the cylinder liner 14 is positioned with its end face 41 that is facing the crankcase 4 adjacent to the gasket 15 or is contacting the gasket 15. The top crankcase part 37 projects to a point below the cylinder liner 14 and secures thereby the cylinder liner 14 in the direction of the longitudinal cylinder axis 12.

In operation, great bearing loads are generated at the crankshaft bearings 18 which are absorbed by the top crankcase part 37 and the bottom crankcase part 38. It has been found that these loads may cause impermissible deformation of the cylinder liner 14 in operation. In order to prevent this, it is provided that the cylinder liner 14 is only contacting or abutting the gasket 15. The gasket 15 forms in this connection together with the top crankcase part 37 a securing element that secures the cylinder liner 14 in the direction of the longitudinal cylinder axis 12. The dimensions of the cylinder 2 and of the cylinder liner 14 are selected such that the cylinder 2 by means of the gasket 15 can be pressed against the top crankcase part 37 so that loads from the crankshaft bearing 18 are absorbed by means of the cylinder 2 and not by means of the cylinder liner 14.

Advantageously, between the end face 41 of the cylinder liner 14 and the gasket 15 a spacing a is formed as shown in FIG. 5. The spacing a can be very small. The spacing a is advantageously smaller than approximately 1 mm and in particular significantly smaller than approximately 1 mm. The spacing a can be minimal. The tolerances of the components are advantageously designed such that the spacing a can also be zero so that a contact is provided but with the proviso that in no event a compression or pressure load between the gasket 15 and the end face 41 can be generated for any of the tolerances that may exist.

The arrow 23 in FIG. 5 illustrates the deflection of the bearing loads of the crankshaft bearing 18 through the gasket 15 into the cylinder 2. The loads in this connection are directed in radial direction outwardly relative to the longitudinal cylinder axis 12 because the crankshaft bearing 18 is arranged completely below the cylinder liner 14. As shown in FIG. 4, in the section plane illustrated in FIG. 4 which contains the axis of rotation 13 of the crankshaft 7 and the longitudinal cylinder axis 12, the outer circumference 43 has a spacing or distance d relative to the longitudinal cylinder axis 12 that is greater than a spacing or distance e of the outer edge 54 of the bearing seat 17 relative to the longitudinal cylinder axis 12. The spacing e corresponds to the spacing of the outer side 42 (illustrated in FIG. 5) of the inner ring 44 of the crankshaft bearing 18 relative to the longitudinal cylinder axis 12. The arrangement of the crankshaft bearing 18 at a position comparatively far inwardly in the crankcase interior 20, i.e., close to the longitudinal cylinder axis 12, results in a compact configuration of the internal combustion engine 1 and a minimal total width of the crankcase 4. In this way, when employing the internal combustion engine 1 for example, in hand-held power tools such as motor chain saws, cut-off machines or the like, a minimal width of the power tool can be achieved.

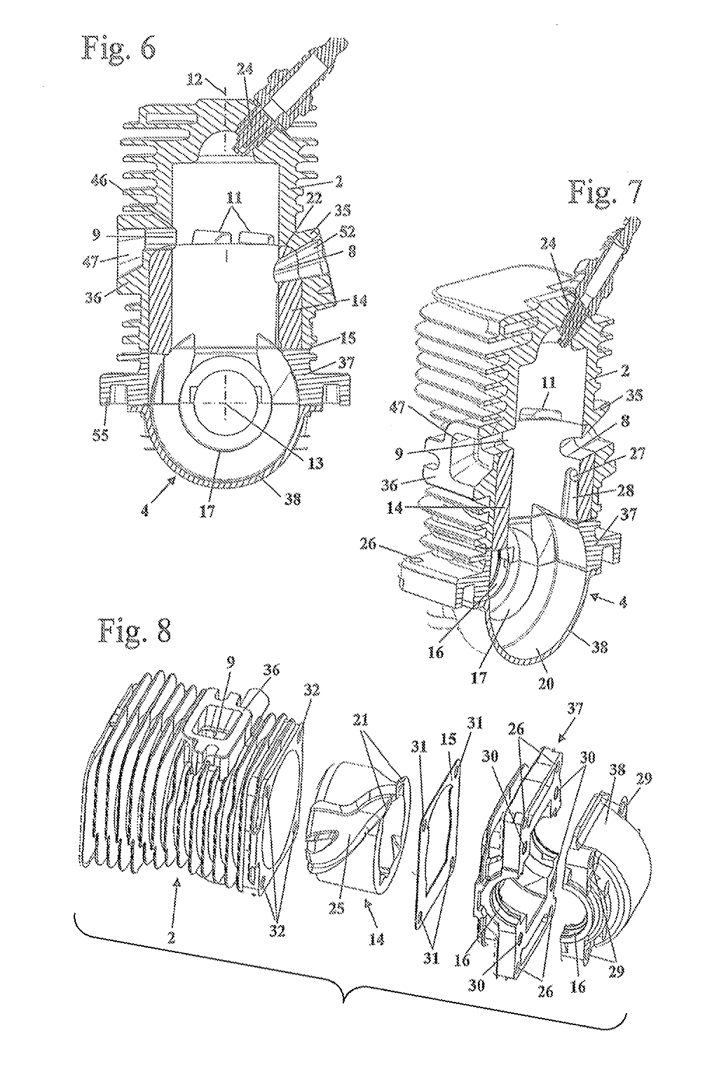

FIG. 6 and FIG. 7 shows a section of the internal combustion engine 1 in a section plane that contains the longitudinal cylinder axis 12 and is positioned perpendicularly to the axis of rotation 13 of the crankshaft 7. As shown in FIG. 6, the inlet opening 8 is completely formed on the cylinder liner 14 while the outlet opening 9 is delimited only in the area that is facing the crankcase 4 by the cylinder liner 14. As also shown in FIG. 6 and FIG. 7, the outlet opening 9 is connected to an outlet passage 47 that extends through an outlet socket 36. An exhaust gas muffler can be attached to the outlet socket 36, for example. As shown in FIG. 6 and FIG. 7, the top crankcase part 37 has a rim 55 that projects outwardly. As shown in FIGS. 7-9, on the rim 55 a total of four fastening openings 26 are arranged with which the internal combustion engine 9 can be screw-connected to adjoining components, for example, a housing part of a power tool.

As shown in FIG. 7, the pulse channel 27 opens at the cylinder liner 14. The cylinder liner 14 has adjacent to the pulse channel 27 at its inner side a depression 28 that, in any position of the piston, provides a connection of the pulse channel 27 to the crankcase interior 20.

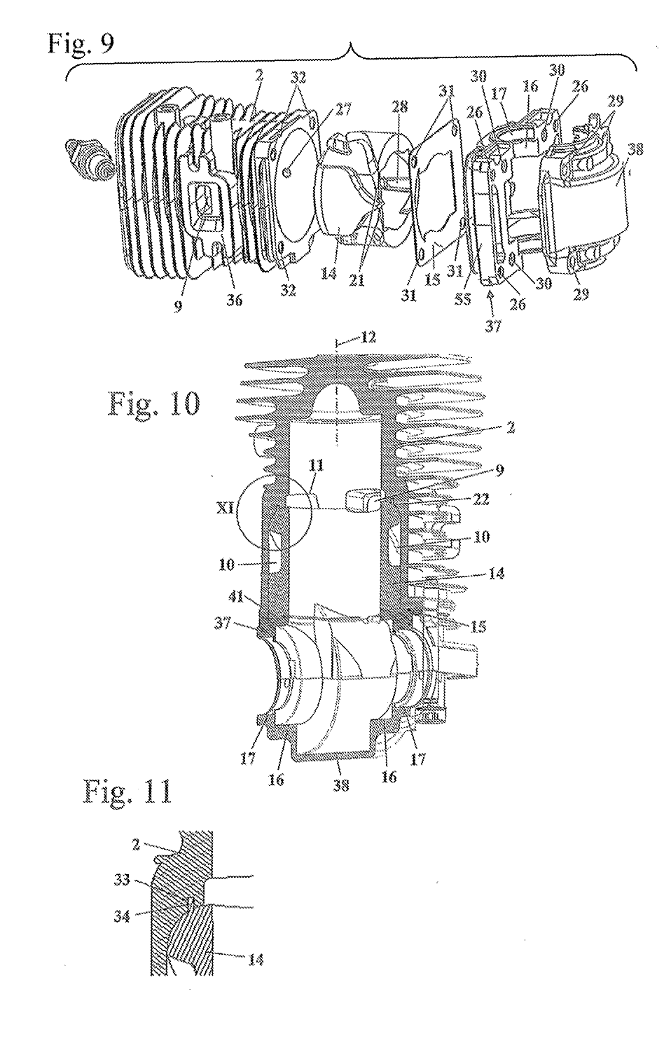

As shown in FIG. 8 and FIG. 9, the bottom crankcase part 38 has four connecting openings 29 that are congruent to four connecting openings 30 of the top crankcase part 37, four connecting openings 31 in the gasket 15, and four connecting openings 32 in the cylinder 2. The screws 19 (FIG. 3) are pushed through the connecting openings 29, and 31 and screwed into the connecting openings 32 that advantageously have an inner thread. Alternatively, it can also be provided that the screws 19 extend from the cylinder 2 to the bottom crankcase part 38. As also shown in FIG. 8 and FIG. 9, the cylinder liner 14 is arranged in a cylindrical receptacle of the cylinder 2. The transfer passages 10 are formed by recesses 25 of the cylinder liner 14. In this way, the cylinder liner 14 and the cylinder 2 can be produced in a simple way. It can also be provided that recesses are also formed in the cylinder 2 and these recesses also delimit the transfer passages 10.

FIG. 10 and FIG. 11 show an embodiment of the internal combustion engine 1 wherein the use of same reference numerals indicates that the same elements are provided as in the preceding Figures.

In the internal combustion engine 1 shown in FIG. 10 and FIG. 11, between the shoulder 22 and the cylinder 2 an additional positional fixation is provided which prevents a relative displacement in radial direction relative to the longitudinal cylinder axis 12 between the cylinder liner 14 and the cylinder 2. The positional fixation is in the form of a groove 33 which is formed in the cylinder 2 and which extends in circular shape about the longitudinal cylinder axis 12. A rim (tongue) 34 that is formed on the cylinder liner 14 is projecting into the groove 33 that has a cross-section matching the cross-section of the groove 33. Alternatively, the rim 34 can be provided on the cylinder 2 and the groove 33 on the cylinder liner 14. A different configuration of the form-fit positional fixation between cylinder 2 and cylinder liner 14 can be advantageous also. The form-fit positional fixation on the shoulder 22 of the cylinder liner 14 is advantageously provided in addition to the described arrangement of the end face 41 at a minimal spacing to or in contact with the gasket 15. However, the described form-fit positional fixation may be expedient also as an alternative to the described arrangement of the end face 41.

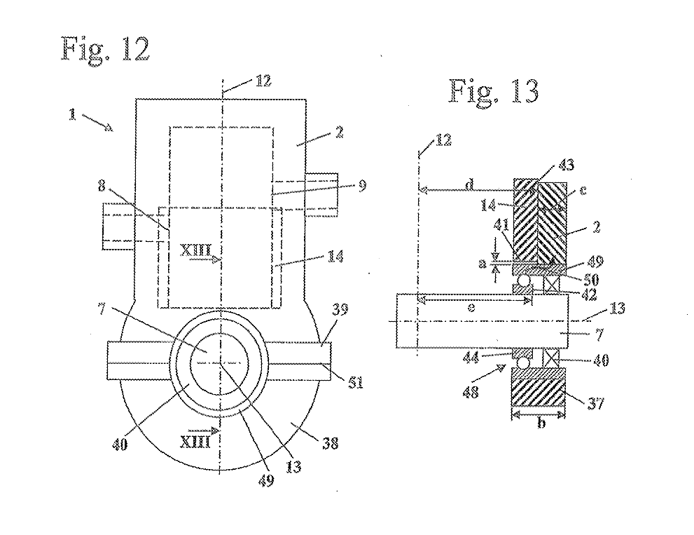

FIG. 12 and FIG. 13 show schematically a further embodiment of an internal combustion engine 1 according to the invention. In the internal combustion engine 1 schematically illustrated in FIG. 12 and FIG. 13, the cylinder 2 extends to the joining plane 51. The cylinder 2 has a cylinder base 39 with which it is secured on the bottom crankcase part 38. The design of the cylinder 2 and of the cylinder liner 14 corresponds to the configuration in the preceding embodiments. As shown in FIG. 13, the cylinder liner 14 is not secured by a crankcase part in its axial position but by the outer ring 49 of a crankshaft bearing 48. The outer ring 49 is of a wider configuration and has a width b that is advantageously approximately corresponding to the total width of the cylinder 2 and the cylinder liner 14. The seal 40 is also supported on the outer ring 49. As schematically shown in FIG. 13, the inner ring 44 in the illustrated section plane is approximately completely arranged below the cylinder liner 14. The spacing d of the outer circumference 43 of the cylinder liner 14 is greater than the spacing e of the outer side 42 of the inner ring 44 of the crankshaft bearing 48. In the direction of the longitudinal cylinder axis 12, a spacing a is formed between the cylinder liner 14 and the outer ring 49: this spacing a is advantageously less than approximately 1 mm, in particular significantly less than approximately 1 mm. Accordingly, no loads can be introduced from the crankcase bearing 48 into the cylinder liner 14. The loads, as indicated by arrow 50, are dissipated outwardly into the cylinder 2. In this way, deformations of the cylinder liner 14 in operation are prevented.

As also shown in FIG. 13, the outer ring 49 is resting across a width c on the cylinder 2; this width c is less than 70% of the width b of the outer ring 49 of the crankshaft bearing 48. The width b and the width c are measured parallel to the axis of rotation 13 of the crankshaft 7, respectively. In the embodiment according to FIG. 12 and FIG. 13, the form-fit positional fixation on the shoulder 22 as shown in FIGS. 10 and 11 can be provided additionally.

The specification incorporates by reference the entire disclosure of German priority document 10 2012 006 852.2 having a filing date of Apr. 4, 2012.

While specific embodiments of the invention have been shown and described in detail to illustrate the inventive principles, it will be understood that the invention may be embodied otherwise without departing from such principles.

What is claimed is:

1. An internal combustion engine comprising:
a cylinder having a longitudinal cylinder axis;
a cylinder liner arranged in the cylinder;
a piston supported so as to move reciprocatingly in a direction of the longitudinal cylinder axis, wherein the piston is guided within the cylinder liner at least across a section of a movement path of the piston in the cylinder;
a combustion chamber disposed in the cylinder and delimited by the piston;
a crankcase;
a crankshaft rotatably supported in the crankcase by at least one crankshaft bearing, wherein the crankshaft is driven in rotation by the piston about an axis of rotation of the crankshaft;
wherein a position of the cylinder liner relative to the crankcase is secured with form fit by a securing element located at an end face of the cylinder liner that is facing the crankcase;
wherein no loads are transmitted into the cylinder liner from the at least one crankshaft bearing through the end face of the cylinder liner that is facing the crankcase.

2. The internal combustion engine according to claim 1, wherein the securing element absorbs loads from the at least one crankshaft bearing.

3. The internal combustion engine according to claim 1, wherein a spacing is provided between the securing element and the end face of the cylinder liner that is facing the crankcase.

4. The internal combustion engine according to claim 3, wherein the spacing is less than approximately 1 mm.

5. The internal combustion engine according to claim 1, wherein the end face of the cylinder liner that is facing the crankcase is contacting the securing element.

6. The internal combustion engine according to claim 1, wherein the securing element is formed at least partially by the crankcase.

7. The internal combustion engine according to claim 6, wherein a bearing seat for the at least one crankshaft bearing is completely formed on the crankcase.

8. The internal combustion engine according to claim 7, wherein the crankcase is comprised of a top crankcase part and a bottom crankcase part, wherein the top crankcase part and the bottom crankcase part together form the bearing seat.

9. The internal combustion engine according to claim 1, wherein the securing element is formed at least partially by an outer ring of the at least one crankshaft bearing.

10. The internal combustion engine according to claim 9, wherein the crankcase is sealed at the crankshaft by a seal relative to the environment, wherein the seal is supported on the outer ring of the at least one crankshaft bearing.

11. The internal combustion engine according to claim 9, wherein the outer ring has a width that is measured parallel to the axis of rotation of the crankshaft cylinder and wherein the outer ring is resting with less than approximately 70% of the width on the cylinder.

12. The internal combustion engine according to claim 1, wherein, measured in a section plane that contains the longitudinal cylinder axis and the axis of rotation of the crankshaft, an outer circumference of the cylinder liner has a first spacing relative to the longitudinal cylinder axis and an outer side of an inner ring of the at least one crankshaft bearing, the outer side facing away from the crankcase, has a second spacing relative to the longitudinal cylinder axis, wherein the first spacing is greater than the second spacing.

13. The internal combustion engine according to claim 1, wherein the combustion chamber has an outlet opening controlled by the piston and wherein the cylinder liner ends before a top side of the outlet opening, the top side facing a cover of the combustion chamber.

14. The internal combustion engine according to claim 1, wherein the cylinder liner is pressed into the cylinder.

15. The internal combustion engine according to claim 1, wherein the cylinder liner has a shoulder at an end that is facing a cover of the combustion chamber and is supported by the shoulder on the cylinder.

16. The internal combustion engine according to claim 1, further comprising at least one transfer passage that connects an interior of the crankcase in the range of bottom dead center of the piston with the combustion chamber, wherein the at least one transfer passage is extending between the cylinder and the cylinder liner and is formed at least partially as a depression of an outer circumference of the cylinder liner.
